(19) United States
(12) Patent Application Publication
(10) Pub. No.: US 2026/0284812 A1
(43) Pub. Date: Sep. 24, 2026

(54) CONSTRUCTION ROBOT FOR THE ASSEMBLY OF MODULAR INTEGRATED CONSTRUCTION AND STEEL STRUCTURE

(71) Applicants: The Hong Kong Polytechnic University, Hong Kong (CN); The University of Hong Kong, Hong Kong (CN)

(72) Inventors: Xiao-Zhou HAN, Hung Hom (CN); Tak-Ming CHAN, Hong Kong (CN)

(21) Appl. No.: 19/538,148

(22) Filed: Feb. 12, 2026

(30) Foreign Application Priority Data
Mar. 21, 2025 (HK) 22025105077.3
Jul. 23, 2025 (CN) 202511015292.0

(51) Int. Cl. B23P 19/06

(52) U.S. Cl. CPC B23P 19/06

(57) ABSTRACT

The invention provides a construction robot for assembling a modular integrated construction and a steel structure, which can install bolts during the assembly process of the modular integrated construction and the steel structure. The construction robot includes a frame, and a climbing system, an adsorption system, a nut installation system, a bolt conveying system that are mounted on the frame, and a control system. The climbing system includes a driving device and a steering device that are mounted on the frame. The adsorption system is used to keep the construction robot in continuous contact with a vertical or inclined object surface during climbing. The bolt conveying system is configured to carry and convey the bolts. The nut installation system can carry and install the nuts that mate with the bolts.

### CROSS-REFERENCE TO RELATED APPLICATIONS

This application claims priority to Hong Kong Application No. 22025105077.3, entitled “CONSTRUCTION ROBOT FOR MODULAR INTEGRATED CONSTRUCTION AND STEEL STRUCTURE” and filed on Mar. 21, 2025, and Chinese Application No. 202511015292.0, entitled “CONSTRUCTION ROBOT FOR MODULAR INTEGRATED CONSTRUCTION AND STEEL STRUCTURE” and filed on Jul. 23, 2025, which are incorporated herein by reference in its entirety.

### TECHNICAL FIELD

The present invention relates to the field of intelligent construction, and in particular, to a construction robot.

### BACKGROUND

In the field of building construction, there has been a heavy reliance on the construction of a large number of workers for construction tasks for a long time, especially for the construction links that are complex and require precise operation, for example, the installation of bolts at the joints of a large number of high-rise modular integrated construction and steel structures, and these critical construction links have consistently demanded experienced and courageous workers to run risks. With the advancement in science and technology, an increasing number of construction robots will replace workers in their jobs.

At present, the application of construction robots remains in a relatively early stage, and the vast majority of construction robots are limited to post-construction tasks (such as painting, cleaning, and maintenance), or to non-core and non-complex construction links of concrete structures. However, for the trend of large-scale application of modular integrated construction (MiC) in the current and future construction industries, in the construction assembly stage, since modules of the MiC are typically connected by bolts, which requires accurate and relatively complex assembly operations. Currently, there is a serious lack of robots in the industry that can directly participate in construction assembly stages of the MiC or a steel structure construction and a steel structure.

### SUMMARY

Therefore, in view of the above-mentioned shortcomings in the existing technology, the present invention provides a construction robot capable of installing bolts in an assembly process of a modular integrated construction and a steel structure.

According to an aspect of the present invention, a construction robot for assembling a modular integrated construction and a steel structure may include a frame, and a climbing system, an adsorption system, a nut installation system and a bolt conveying system that are mounted on the frame, and a control system. The climbing system comprises a driving device and a steering device mounted on the frame; the adsorption system is configured to keep the construction robot in continuous contact with a vertical or inclined object surface during climbing of the construction robot; the bolt conveying system is configured to carry and convey a bolt; the nut installation system is capable of carrying and mounting a fastening nut mating with the bolt; and the control system is configured to control actions of the climbing system, to control actions of the adsorption system, to control the bolt conveying system to convey the bolt, and to control the nut installation system to install the fastening nut onto the bolt after the bolt is conveyed in place.

According to an embodiment of the present invention, the frame may include an upper plate and a lower plate, the upper plate and the lower plate divide the frame into three regions, a region above the upper plate is an upper region, a region below the lower plate is a lower region, and a region between the upper plate and the lower plate is a middle region.

According to an embodiment of the present invention, a plurality of columns may be fixed on a periphery of the upper plate, the plurality of columns extend toward the lower plate and are parallel to each other, the adsorption system includes fans or magnet discs respectively mounted at ends of the plurality of columns, and the fans or the magnet discs are located below the lower plate.

According to an embodiment of the present invention, the nut installation system may include a wrench motor and an intelligent torque wrench, the wrench motor is mounted above the lower plate, the intelligent torque wrench is located below the lower plate and is provided with a wrench shaft, and the wrench shaft is in transmission connection with an output shaft of the wrench motor.

According to an embodiment of the present invention, the intelligent torque wrench may further include a first lifting device mounted on the upper plate. The wrench motor is mounted on the first lifting device to drive the intelligent torque wrench to lift and lower.

According to an embodiment of the present invention, the intelligent torque wrench may include a housing, a driving mechanism and a driven mechanism mounted in the housing, and a sleeve connected to the driving mechanism through the driven mechanism; the sleeve is rotatable relative to the housing; a through hole is provided in the sleeve; and a shape of the through hole is matched with an outer contour shape of the fastening nut.

According to an embodiment of the present invention, the housing may include an annular head portion and a rod portion fixed to the head portion, and a longitudinal centerline of the rod portion passes through a center of the annular head portion.

According to an embodiment of the present invention, the driving mechanism may include a linear motor mounted in the rod portion; the driven mechanism includes a ratchet wheel, a pawl engaged with the ratchet wheel, and a rack, a first driven gear, a second driven gear and a ring gear which are engaged in sequence. The rack is connected to an output shaft of the linear motor, the ring gear is mounted in the head portion, the ratchet wheel is rotatably mounted in the ring gear, an end of the pawl is connected to the ring gear, a groove is formed in an inner side of the ring gear, a compression spring is mounted in the groove, and a pre-tightening force of the compression spring acts on the pawl, so that a hook portion of the pawl cooperates with a ratchet of the ratchet wheel.

According to an embodiment of the present invention, an end of the rod portion away from the head portion may be fixed with the wrench shaft.

According to an embodiment of the present invention, the bolt conveying system may include a first bolt conveying device and a second bolt conveying device, the first bolt conveying device is mounted on the upper plate for driving the bolt to move, and the second bolt conveying device is mounted on the lower plate in a liftable manner for driving the bolt to rotate.

According to an embodiment of the present invention, the first bolt conveying device may include a first bracket, two first conveying motors and two first rollers, the first bracket is mounted on the upper plate; the two first conveying motors are mounted on two sides of the first bracket; the two first rollers are respectively mounted on output shafts of the two first conveying motors; the two first rollers are arranged opposite to each other, clamp the bolt on two sides of the bolt; and central axes of the two first rollers are parallel to each other and perpendicular to a central axis of the bolt.

According to an embodiment of the present invention, the first bolt conveying device may further include two first mounting rods parallel to each other and two first telescopic devices parallel to each other; the two first mounting rods are fixed on two sides of the first bracket; the two first conveying motors are rotatably mounted on the two first mounting rods, respectively; the first conveying motors is provided with a first lug; one end of each of the two first telescopic devices is connected to a corresponding first mounting rod of the two first mounting rods, while the other end thereof is connected to the first lug of a corresponding first conveying motor of the two first conveying motors; and the two first telescopic devices are configured to drive the two first conveying motors to rotate around the two first mounting rods, respectively.

According to an embodiment of the present invention, the first bolt conveying device may further include a first counterweight, which is connected to the first bracket and located on a side opposite to the first conveying motor; and/or the first bolt conveying device further includes a first limiting structure, which is disposed on the first bracket to prevent the bolt from skewing.

According to an embodiment of the present invention, the second bolt conveying device may include a second lifting device, a second bracket, two second conveying motors and two second rollers, the second lifting device is mounted on the lower plate; the second bracket is mounted on the second lifting device and located below the lower plate; the two second conveying motors are mounted on two sides of the second bracket; the two second rollers are arranged opposite to each other, clamp a bolt on two sides of the bolt, and are respectively driven by the two second conveying motors; and central axes of the two second rollers are parallel to each other and parallel to the central axis of the bolt.

According to an embodiment of the present invention, the second bolt conveying device may further include two second mounting rods parallel to each other and two second telescopic devices parallel to each other; the two second mounting rods are fixed on two sides of the second bracket; the two second conveying motors are rotatably mounted on the two second mounting rods, respectively; each of the second conveying motors is provided with a second lug; one end of each of the two second telescopic devices is connected to a corresponding second mounting rod of the two second mounting rods, while the other end is connected to the second lug of a corresponding second conveying motor of the two second conveying motors; and the two second telescopic devices are configured to drive the two second conveying motors to rotate around the two second mounting rods, respectively.

According to an embodiment of the present invention, the second bolt conveying device may further include a second counterweight, which is mounted on the lower plate and connected to the second bracket.

According to an embodiment of the present invention, the driving device may include two driving motors and two driving wheels mounted on left and right sides of the lower plate, and the two driving wheels are in transmission connection with output shafts of the two driving motors, respectively.

According to an embodiment of the present invention, the steering device may include steering wheels rotatably mounted on left and right sides of the lower plate, a turntable rotatably mounted on the lower plate, two first connecting rods respectively movably connected between two sides of the turntable and the two steering wheels, and a steering motor mounted on the lower plate, and the turntable is in transmission connection with an output shaft of the steering motor.

According to an embodiment of the present invention, pivoting members may be disposed on left and right sides of the lower plate, respectively; two steering wheels are respectively fixed on the two pivoting members; and the steering device further includes a second connecting rod connecting the two pivoting members.

According to an embodiment of the present invention, there are a plurality of bolt conveying systems are provided; and the frame is further provided with at least one spare nut frame, each of which has an external thread.

According to an embodiment of the present invention, the construction robot may include a bolt and a fastening nut mating with the bolt. The bolt is clamped and carried by the bolt conveying system, and the fastening nut is carried by the nut installation system.

According to an embodiment of the present invention, a primary camera may be disposed on a top of the frame, and a bottom camera may be disposed on a bottom of the frame.

According to an embodiment of the present invention, the system may further include a 360°LiDAR system and/or a battery pack and/or an anti-fall device disposed on the frame.

The construction robot of the present invention includes a climbing system, an adsorption system, a nut installation system, at least one bolt conveying system, and a control system. By the coordination of the climbing system and the adsorption system, the construction robot can climb from a low position to a high position of the construction, insert the bolts conveyed by the bolt conveying system to the construction modules to be connected, and further mount the fastening nut to the bolt through the nut installation system, and finally complete the connection of the construction modules. The construction robot of the present invention is used to replace manual labor to achieve higher-quality and faster bolt installation and tightening. The labor costs are significantly reduced, the construction cycle is shortened, and the construction quality and safety are improved.

### BRIEF DESCRIPTION OF THE DRAWINGS

FIG. 1A shows a schematic view of an application scenario for a construction robot of the present invention.

FIG. 1B is an enlarged view of part M in FIG. 1A.

FIG. 2 shows a perspective view of an embodiment of a construction robot of the present invention from an angle.

FIG. 3 shows a perspective view of an embodiment of a construction robot of the present invention from another angle.

FIG. 4 shows a perspective view of an embodiment of a construction robot of the present invention from yet another angle.

FIG. 5 is a front view of FIG. 2.

FIG. 6 is a rear view of FIG. 2.

FIG. 7 is a top view of FIG. 2.

FIG. 8 is a bottom view of FIG. 2.

FIG. 9 is a side view of FIG. 2.

FIG. 10 shows a perspective view of an embodiment of a construction robot of the present invention from an angle, in which a cover shell is hidden.

FIG. 11 shows a perspective view of an embodiment of the construction robot of the present invention from an angle, in which an upper plate is further hidden on the basis of FIG. 10.

FIG. 12 shows a perspective view of an embodiment of the construction robot of the present invention from an angle, in which part of structures mounted on a lower plate is further hidden on the basis of FIG. 11.

FIG. 13 shows a perspective view of an embodiment of the construction robot of the present invention from an angle, in which the lower plate is further hidden on the basis of FIG. 12.

FIG. 14 is a perspective view of FIG. 12 from another angle.

FIG. 15 shows a perspective view of a first lifting device in the construction robot of the present invention.

FIG. 16 shows a perspective view of two first bolt conveying devices and an upper plate in two bolt conveying systems in the construction robot of the present invention.

FIG. 17 is a perspective view of the two first bolt conveying devices shown in FIG. 16, with the upper plate hidden.

FIG. 18 is a side view of FIG. 17.

FIG. 19 is a top view of FIG. 17.

FIG. 20 shows a perspective view of one first bolt conveying device of the bolt conveying system in the construction robot of the present invention.

FIG. 21 is a front view of FIG. 20.

FIG. 22 is a perspective exploded view of the first bolt conveying device shown in FIG. 20 from an angle.

FIG. 23 is a perspective exploded view of the first bolt conveying device shown in FIG. 20 from another angle.

FIG. 24 shows a perspective exploded view of a second bolt conveying device of the bolt conveying system in the construction robot of the present invention.

FIG. 25 is a perspective assembly view of the second bolt conveying device shown in FIG. 24.

FIG. 26 shows a perspective view of two bolt conveying systems, two bolts and a nut installation system in the construction robot of the present invention from an angle.

FIG. 27 shows a perspective view of the two bolt conveying systems, the two bolts and the nut installation system in FIG. 26 from another angle.

FIG. 28 is a front view of FIG. 27.

FIG. 29 is a rear view of FIG. 27.

FIG. 30 is a right view of FIG. 27.

FIG. 31 is a partial exploded view of an intelligent torque wrench in the construction robot of the present invention from an angle.

FIG. 32 is a partial exploded view of the intelligent torque wrench in the construction robot of the present invention from another angle.

FIG. 33 is a schematic view of a driving mechanism and a driven mechanism in an intelligent torque wrench in a construction robot of the present invention.

FIGS. 34 to 40 show schematic views of various steps of installing bolts on a modular integrated construction by a construction robot.

FIG. 41 is a perspective view of another embodiment of a construction robot of the present invention.

In the drawings: 1000, module; 2000, connecting plate; 3000, through hole; 100, frame; 200, climbing system; 300, adsorption system; 400, bolt conveying system; 500, nut installation system; 110, upper plate; 111, front protrusion; 1110, first notch; 1130, second notch; 112, middle protrusion; 113, rear protrusion; 114, column; 120, lower plate; 121, spare nut frame; 130, support column; 140, cover shell; 150, lifting platform; 160, lifting motor; 210, driving device; 211, driving wheel; 212 driving motor; 220, steering device; 221, steering wheel; 222, turntable; 223, first connecting rod; 224 steering motor; 225 pivoting member; 2251 pivoting shaft; 226, second connecting rod; 310, fan driving motor; 320, impeller; 330, magnet disc; 410, first bolt conveying device; 411, first bracket; 412, first conveying motor; 4121, protective sheet; 4122, first lug; 413, first roller; 414, first mounting rod; 415, first telescopic device; 416, first counterweight; 417, connecting structure; 418, first limiting structure; 420 second bolt conveying device; 421 second bracket; 422 second conveying motor; 4222 second lug; 423 second roller; 424, second mounting rod; 425, second telescopic device; 426, second counterweight block; 427, telescopic rod; 510, wrench motor; 514, wrench shaft; 520, intelligent torque wrench; 521, head portion; 522, rod portion; 523, sleeve; 524, linear motor; 525, rack; 526, first driven gear; 527, second driven gear; 528, ring gear; 5280, groove; 531, ratchet wheel; 532 pawl; 540, compression spring; 610, 360° LiDAR system; 620, primary camera; 630, anti-fall device; 640, control chip; 650, bottom camera; 700, battery pack; 800, bolt; 900, fastening nut; 5000, fixing nut.

### DETAILED DESCRIPTION

Typical embodiments embodying the features and advantages of the present invention will be described in detail in the following description. It should be understood that the present invention can have various modifications in different embodiments without departing from the scope of the present invention, and the description and drawings herein are essentially illustrative and are not intended to limit the present invention.

In the following description of various exemplary embodiments of the invention, reference is made to the accompanying drawings, which form a part hereof, and in which various exemplary structures, systems and steps for implementing aspects of the invention are shown by way of example. It should be understood that other specific solutions of components, structures, exemplary devices, systems, and steps may be utilized, and structural and functional modifications may be made without departing from the scope of the present invention. Moreover, although the terms “above”, “between”, “within”, etc., may be used in this specification to describe different exemplary features and elements of the present invention, these terms are used herein only for convenience, for example, based on the orientations of the examples depicted in the drawings. Nothing in this specification should be construed as requiring specific three-dimensional orientations of structures to fall within the scope of the present invention.

A modular integrated construction (MiC) consists of a plurality of modules, and on-site installation includes a large number of bolt connections, that is, two horizontally (left-right) adjacent modules or two vertically (upper-lower) adjacent modules are connected together by bolts. The construction robot provided by the present invention is mainly used for automatically installing bolts, connecting adjacent modules, and finally forming a modular integrated construction.

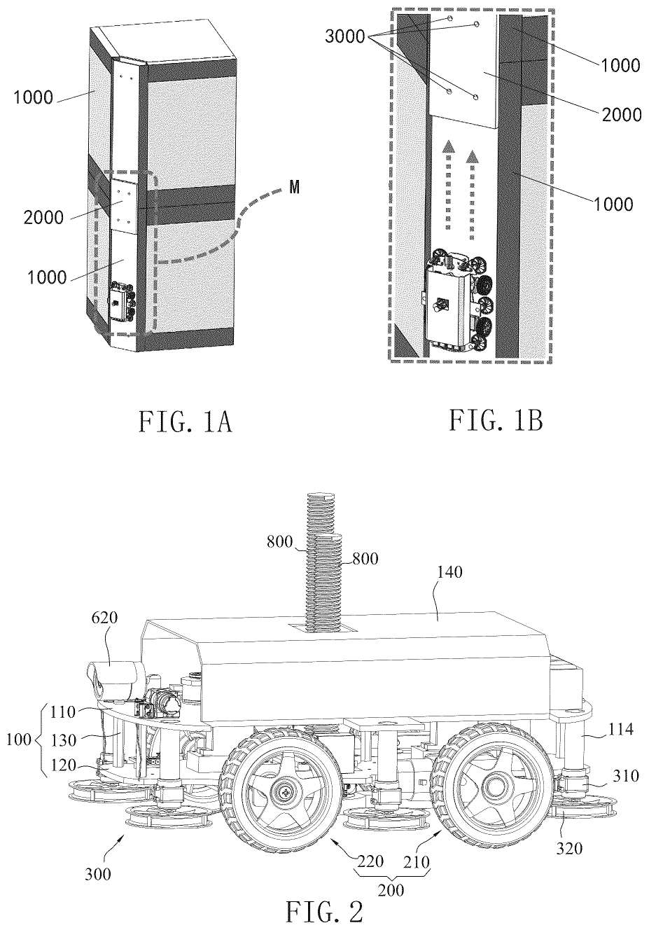

For example, as shown in FIG. 1A and FIG. 1B, each of two vertically adjacent modules 1000 of the modular integrated construction is provided with two through holes, and the connecting plate 2000 is provided with four through holes 3000. Four bolts respectively pass through the through holes 3000 on the connecting plate 2000 and the module 1000 to connect the two modules 1000.

The construction robot of the present invention can be directly used to perform the most critical bolt installation in the construction and assembly stage of the modular integrated construction to assemble various modules of the modular integrated construction, and apply an accurate bolt pre-tightening force to ensure the construction quality. Specifically, the construction robot of the present invention can carry bolts, climb upward along the lower module 1000 to positions of the bolt holes 3000, pass a bolt through a bolt hole 3000 and tighten a fastening nut to complete the automatic installation of the bolt, and the specific working process will be described in detail later. The structure of the construction robot of the present invention will be described below.

A direction of forward movement for the construction robot of the present invention is defined as forward, and an opposite direction is defined as rearward; during the movement of the construction robot, a direction towards the building is defined as downward, and a direction away from the building is defined as upward.

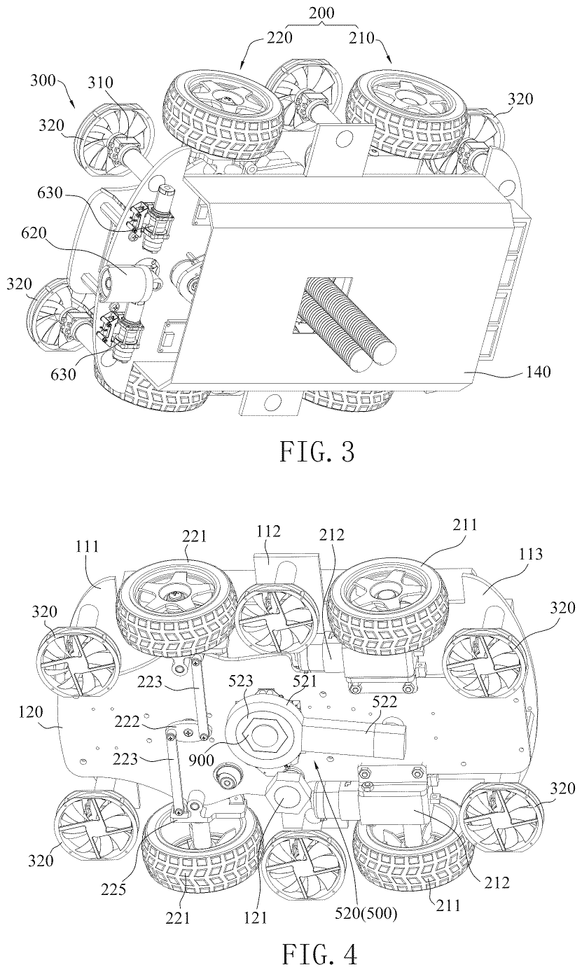

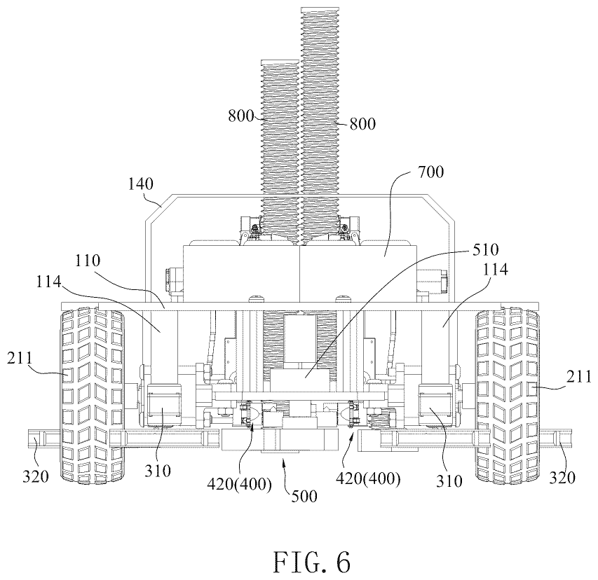

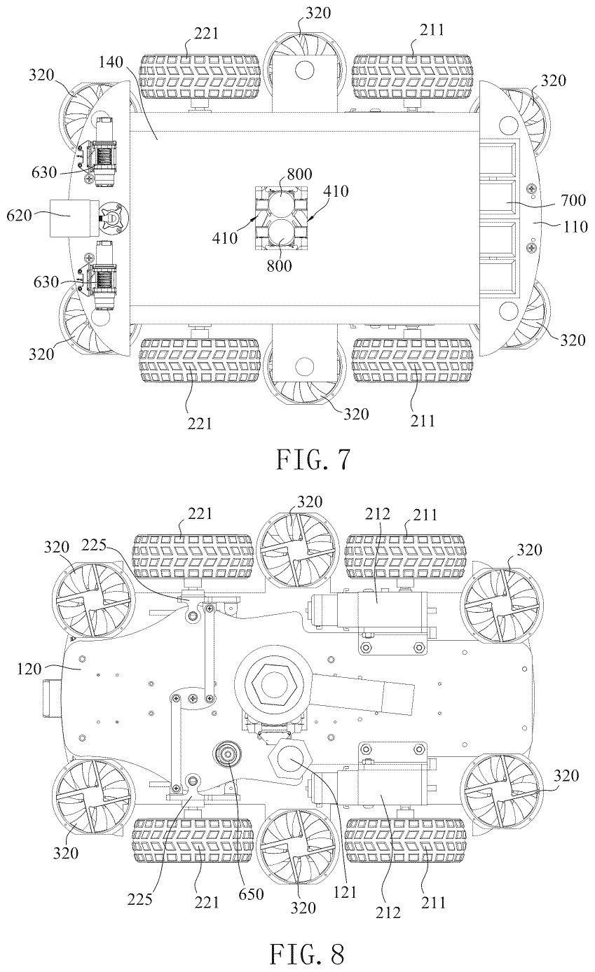

Referring to FIGS. 2 to 9, a construction robot of an embodiment of the present invention includes a frame 100, and a climbing system 200, an adsorption system 300, two bolt conveying systems 400 and a nut installation system 500 that are mounted on the frame 100, and a control system.

The climbing system 200 includes a driving device 210 and a steering device 220 that are mounted on the frame 100. The adsorption system 300 is configured to keep the construction robot in continuous contact with a vertical or inclined object surface during climbing of the construction robot. Each bolt conveying system 400 is configured to carry and convey a bolt. The nut installation system 500 can carry a fastening nut mating with the bolt. The control system is configured to control an adsorption force of the adsorption system 300, to control the action of the climbing system 200, to control the bolt conveying system 400 to convey the bolt, and to control the nut installation system 500 to install the fastening nut onto the bolt after the bolt is conveyed in place.

In other embodiments, the number of bolt conveying systems 400 is not limited to two, and may alternatively be only one, or three, four, eight, etc.

The construction robot of the present invention can replace a large number of manual operations, reducing the investment of labor costs. Moreover, the efficient and accurate operation mode of the construction robot reduces material waste and rework costs caused by installation errors or installation inaccuracies, thereby significantly reducing costs.

The bolt conveying system and the nut installation system adopt a high-precision mechanical structure under the control of the control system, so that accurate positioning and installation of the bolt and the nut can be realized, and the installation precision can reach a millimeter level, thereby effectively avoiding problems such as bolt misalignment and loosening that may occur in manual installation, and significantly improving the reliability and stability of building module connection.

Referring to FIG. 2, the frame 100 is configured to carry each of the systems, and in this embodiment, the frame 100 includes an upper plate 110, a lower plate 120, and a support column 130 fixed between the upper plate 110 and the lower plate 120. The upper plate 110 and the lower plate 120 may be parallel to each other. The upper plate 110 and the lower plate 120 divide the frame 100 into three regions, a region above the upper plate 110 is an upper region, a region below the lower plate 120 is a lower region, and a region between the upper plate 110 and the lower plate 120 is a middle region. The components of each system in the construction robot of the present invention can be respectively arranged in different areas according to their respective functions and space requirements, which realizes the reasonable utilization of space and the ordered layout of the systems, not only improves the overall stability of the robot, but also facilitates the coordination between the systems, thereby improving the working efficiency and performance of the robot.

A cover shell 140 may further be mounted on the upper plate 110, and the cover shell 140 can shield the structure mounted on the upper plate 110, providing protection. The cover shell 140 can not only effectively prevent the interference and damage of dust, rain and the like to the system components on the upper plate 110, but also improve the aesthetics and integrity of the construction robot to a certain extent.

The frame 100 is primarily used for mounting various systems to provide a stable support platform for the construction robot. However, the present invention is not limited to the structure including the two parallel upper plate 110 and lower plate 120. In other embodiments, other frames capable of carrying or mounting structural components are also available, so that the construction robot of the present invention can adapt to different application scenarios and requirements.

Referring to FIG. 10, a protrusion extended outwardly is disposed on an outer periphery of the upper plate 110. In detail, the left and right sides of the front, middle and rear portions of the upper plate 110 are provided with a pair of front protrusions 111, a pair of middle protrusions 112 and a pair of rear protrusions 113, respectively. Each pair of protrusions is arranged axially symmetrical relative to a longitudinal centerline X of the construction robot.

Along the front-rear direction, a notch is formed between adjacent protrusions on the upper plate 110. That is, first notches 1110 are provided between the front protrusions 111 and the middle protrusions 112, and second notches 1130 are provided between the middle protrusions 112 and the rear protrusions 113.

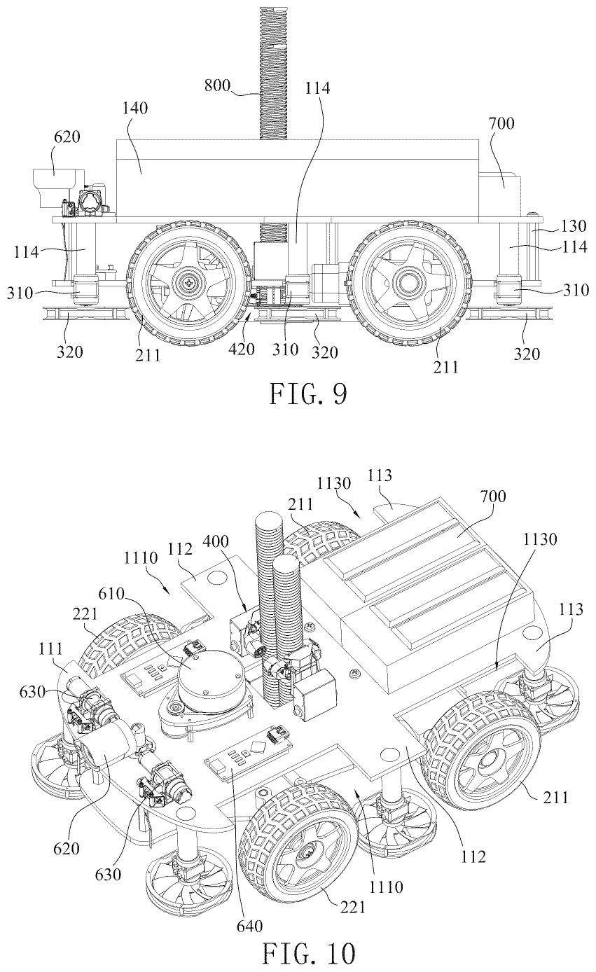

Referring to FIGS. 9 and 10, each protrusion is fixed with a column 114, the column 114 may be perpendicular to the upper plate 110 and extend toward the lower plate 120, and the plurality of columns 114 are parallel to each other.

Referring to FIGS. 9 and 10, the adsorption system 300 includes fans respectively mounted at ends of the plurality of columns 114. Each fan includes a fan driving motor 310 mounted on the column 114 and an impeller 320 mounted on an output shaft of the fan driving motor 310. The impeller 320 is located below the lower plate 120.

When the fan driving motor 310 drives the fan to operate, the impeller 320 can generate a powerful negative pressure, thereby forming a stable adsorption force between the construction robot and a building surface. Since the plurality of fans is arranged around the peripheral of the lower plate 120, i.e., in a distributed layout, and the impeller 320 is located below the lower plate 120, i.e., close to the building surface, the adsorption force is evenly distributed at the bottom of the construction robot, which enhances the adhesion and stability of the construction robot on the building surface, so that the robot can be effectively prevented from sliding or falling off on the vertical or inclined building surface.

In an embodiment, the fan may be a variable frequency fan. The variable frequency fan offers high rotational speed adjustment precision, which can realize Newton-level adsorption force adjustment. The adsorption force can be adjusted in real time under the control of the control system, so that the robot can maintain the best adsorption performance under different operational conditions, and the adaptability and flexibility of the construction robot are improved. In addition, the fan is mounted at the end of the column 114, so that maintenance and replacement are more convenient.

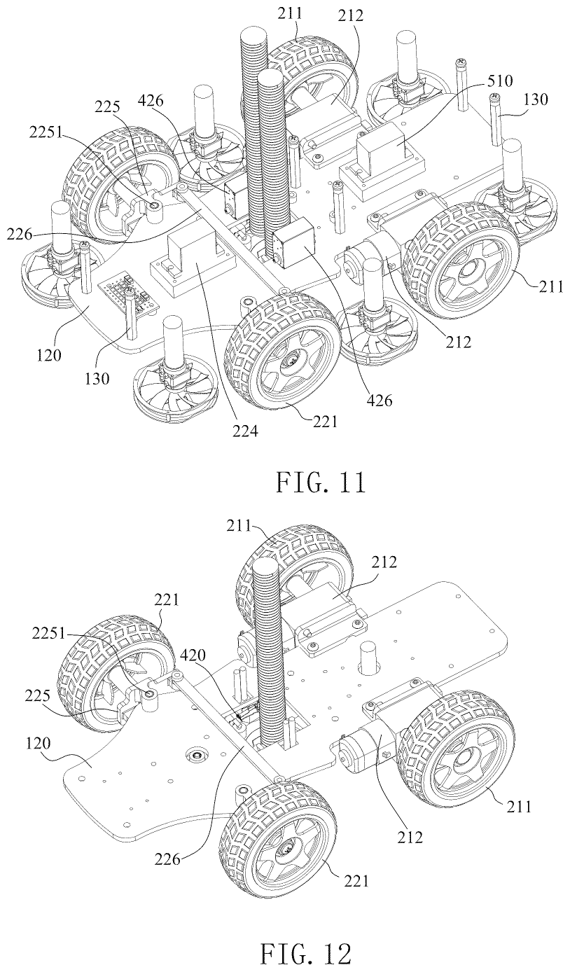

Referring to FIGS. 11 and 12, the driving device 210 includes two driving wheels 211 and two driving motors 212. The two driving motors 212 are symmetrically mounted on left and right sides of the lower plate 120 relative to the longitudinal centerline of the lower plate 120; the two driving wheels 211 are respectively mounted on the left and right sides of the lower plate 120 and are in transmission connection with the output shaft of the driving motor 212. When the two driving motors 212 are activated, the two driving wheels 211 can be driven to rotate, thereby driving the robot to climb on the building surface.

The two driving motors 212 are arranged in a left-right symmetrical configuration, so that the robot can maintain good balance during climbing, avoid rollover caused by a shift in center of gravity, and significantly improve the safety of the robot during operation.

The symmetrical design of the two driving wheels 211 enables driving forces on the two sides of the robot to be consistent when climbing, further enhancing the balance and stability of the robot on different building surfaces.

Each driving wheel 211 is driven by an independent driving motor 212, so that the rotational speed and torque can be independently adjusted to achieve precise speed control and climbing direction adjustment. The driving motors 212 may adopt high-precision servo motors. In coordination with the control system, the driving motors 212 may dynamically adjust power output according to the motion state and load condition of the robot, thereby avoiding unnecessary energy waste. For example, when the robot is climbing upward and carrying bolts, the load is heavy, and the driving motors 212 can be controlled to increase power output to provide sufficient driving forces; when the robot is climbing downward after completing the installation of the bolt, power output can be reduced to save energy consumption, which helps extend the operational endurance of the robot.

Referring to FIG. 10, upper portions of the two driving wheels 211 are correspondingly disposed in the second notches 1130 of the upper plate 110, thereby ensuring that the driving wheel 211 has sufficient rotation space without increasing an overall height of the robot. In other words, the design of embedding portions of the driving wheels 211 into the notches of the upper plate 110 not only reduces the overall height of the construction robot, but also makes the overall structure of the robot more compact, thereby saving space, improving the space utilization efficiency of the robot, and facilitating improving the safety and reliability of the robot during climbing.

Referring to FIGS. 4 and 11, the steering device 220 includes two steering wheels 221, a turntable 222, two first connecting rods 223, and a steering motor 224. The two steering wheels 221 are rotatably mounted on the left and right sides of the lower plate 120. Specifically, the front portion of the lower plate 120 is provided with two pivoting members 225 at left and right symmetrical positions along the longitudinal centerline, the two pivoting members 225 can rotate around the pivoting shaft 2251 fixed to the lower plate 120, and axles of the two steering wheels 221 are fixedly connected to the two pivoting members 225 respectively, so that the two steering wheels 221 can rotate around the pivoting shaft 2251 to realize the steering function of the construction robot. Moreover, the two steering wheels 221 can also rotate around their respective axles to realize the climbing function of the robot.

The turntable 222 is rotatably mounted on the lower plate 120 and located below the lower plate 120. The two first connecting rods 223 are movably connected between two sides of the turntable 222 and the two pivoting members 225, respectively. The steering motor 224 is mounted on an upper surface of the lower plate 120, an output shaft of the steering motor 224 passes through the lower plate 120, and the turntable 222 is mounted on the output shaft of the steering motor 224. When the steering motor 224 is activated, the turntable 222 is driven to rotate, and the turntable 222 drives the two pivoting members 225 to rotate around the pivot shaft 2251 through the two first connecting rods 223, and further drives the two steering wheels 221 to rotate around the pivot shaft 2251, thereby achieving steering.

In other embodiments, the turntable 222 may also be in transmission connection with the output shaft of the steering motor 224 through a driven mechanism such as gear transmission, belt transmission, etc.; in addition, the shape of the turntable 222 is not limited to a disc shape, and may also be a long strip or other shapes, as long as the steering function can be realized by the driving of the steering motor 224.

In this embodiment, the steering motor 224 may adopt a high-precision servo motor, which can adjust the steering angle in real time in coordination with the control system, thereby improving the steering precision and responsiveness.

The two steering wheels 221 can not only rotate around the pivot shaft 2251 to realize steering, but also rotate around their respective axles to realize walking, so that the robot can adjust the posture more flexibly during steering. By independently controlling the steering motor 224 and the driving motors 212, the robot can flexibly implement a plurality of motion modes, such as linear walking, turning, and in-situ rotation.

Similar to the driving motor 212, under the control of the control system, the steering motor 224 can also dynamically adjust power output according to the motion state and load condition of the robot, which avoids unnecessary energy waste on the one hand, and can provide sufficient steering force on the other hand. Moreover, it helps to extend the operational endurance of the robot.

Referring to FIG. 11, further, the steering device 220 further includes a second connecting rod 226, two ends of the second connecting rod 226 are rotatably connected to the two pivoting members 225 respectively, and the second connecting rod 226 is located above the lower plate 120. By connecting the two pivoting members 225 through the second connecting rod 226, the steering synchronization of the two steering wheels 221 is improved, significantly reducing the vibration and shaking that may occur during the steering process, so that the robot more stable during steering, and the direction can be adjusted more precisely.

Referring to FIG. 10, upper portions of the two steering wheels 221 are correspondingly disposed in the first notches 1110 of the upper plate 110, thereby ensuring that the steering wheels 221 have sufficient rotation space without increasing the overall height of the robot. In other words, the design of embedding portions of the steering wheels 221 into the notch of the upper plate 110 not only reduces the overall height of the construction robot, but also makes the overall structure of the robot more compact, thereby saving space, improving the space utilization efficiency of the robot, and facilitating improving the safety and reliability of the robot during climbing.

Referring to FIGS. 4 and 8, the nut installation system 500 includes a wrench motor 510 (see FIG. 11) and an intelligent torque wrench 520, the wrench motor 510 may be a high-precision servo motor mounted above the lower plate 120, and the intelligent torque wrench 520 is located below the lower plate 120.

The smart torque wrench 520 includes a housing, a driving mechanism, a driven mechanism, and a sleeve 523. The driving mechanism and the driven mechanism are mounted in the housing, the sleeve 523 is in transmission connection with the driving mechanism through the driven mechanism, the sleeve 523 is rotatable relative to the housing under the driving of the driving mechanism, a through hole is provided in the sleeve 523, a shape of the through hole is matched with the outer contour shape of the fastening nut 900, and the fastening nut 900 is fitted in the through hole. The intelligent torque wrench 520 can be an existing hydraulic torque wrench or hollow hydraulic wrench, which can complete the installation of the fastening nut 900 of the present invention.

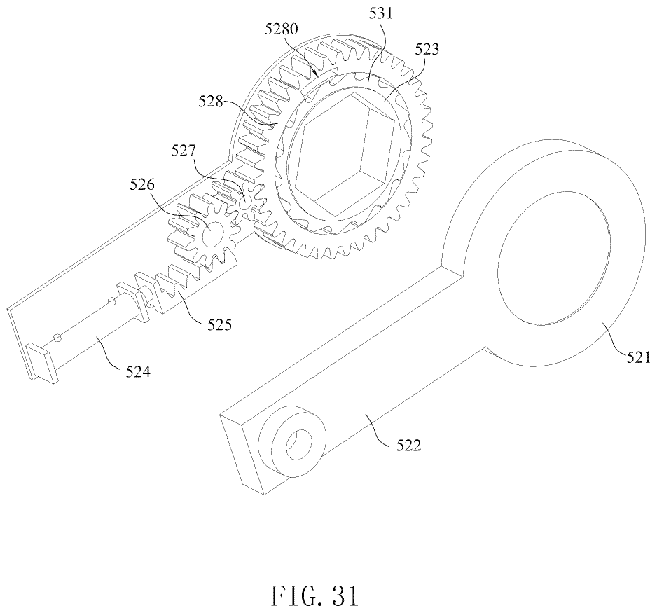

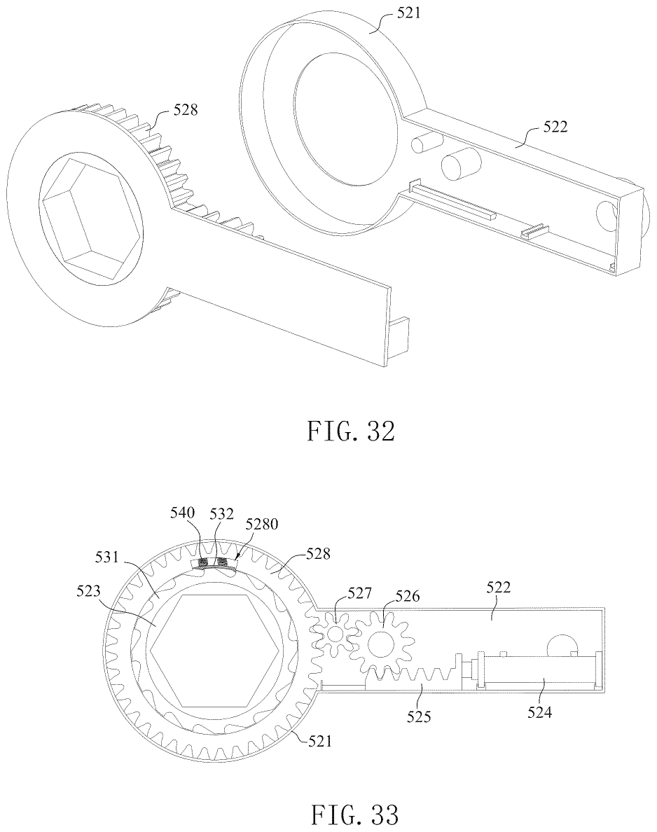

Referring to FIGS. 31 to 33, in this embodiment, a housing of the intelligent torque wrench 520 includes an annular head portion 521 and a rod portion 522 fixed to the head portion 521.

The driving mechanism includes a linear motor 524 mounted in the rod portion 522. In other embodiments, the driving mechanism may alternatively be other types of linear or telescopic driving mechanisms, such as a miniature linear servo electric cylinder, etc.

The driven mechanism includes a ratchet wheel 531, a pawl 532 cooperating with the ratchet wheel 531, and a rack 525, a first driven gear 526, a second driven gear 527, and a ring gear 528 that are sequentially engaged. The rack 525 is connected to an output shaft of the linear motor 524, the ring gear 528 is mounted in the head portion 521, the ratchet wheel 531 is rotatably mounted in the ring gear 528, an end of the pawl 532 is connected to the ring gear 528, a groove 5280 is disposed on an inner side of the ring gear 528, a compression spring 540 is mounted in the groove 5280, and a pre-tightening force of the compression spring 540 acts on the pawl 532 to engage a hook portion of the pawl 532 with a ratchet of the ratchet wheel 531.

Referring to FIG. 33, the linear motor 524 is activated, driving the rack 525 to reciprocate, and the ring gear 528 reciprocates in the forward and reverse directions by the transmission of the first driven gear 526 and the second driven gear 527. When the ring gear 528 rotates in the forward direction, for example, a clockwise direction, the pawl 532 connected to the ring gear 528 drives the ratchet wheel 531 and the ring gear 528 to rotate synchronously, the sleeve 523 fixed to the ratchet wheel 531 rotates accordingly, and thereby the fastening nut engaged with the sleeve 523 is tightened on the bolt; when the ring gear 528 rotates in the reverse direction, for example, a counterclockwise direction, the pawl 532 slides on an outer surface of the ratchet wheel 531, and thereby the ratchet wheel 531 does not rotate with the rotation and the sleeve 523 fixed to the ratchet wheel 531 remains stationary; and when the ring gear 528 rotates again in the forward direction, the fastening nut is driven again by the pawl 532, the ratchet wheel 531 and the sleeve 523 to be tightened on the bolt. Under the control of the control system, the linear motor 524 can accurately control the displacement and cycle count of reciprocating movements of the rack 525, and enabling intelligent torque control, and the torque range and accuracy of the intelligent torque wrench can ensure sufficient, accurate and specification-compliant tightening of the nut, thereby completing accurate assembly and fastening of the fastening nut with high accuracy.

The intelligent torque wrench of this embodiment, with a longitudinal centerline of the rod portion 522 passing through the center of the annular head portion 521, is elongated in shape, compact in structure, small in size, and is suitable for operation in narrow and small spaces, by the driving of the wrench motor 510, the intelligent torque wrench can rotate to pick up a spare fastening nut on the spare nut frame 121.

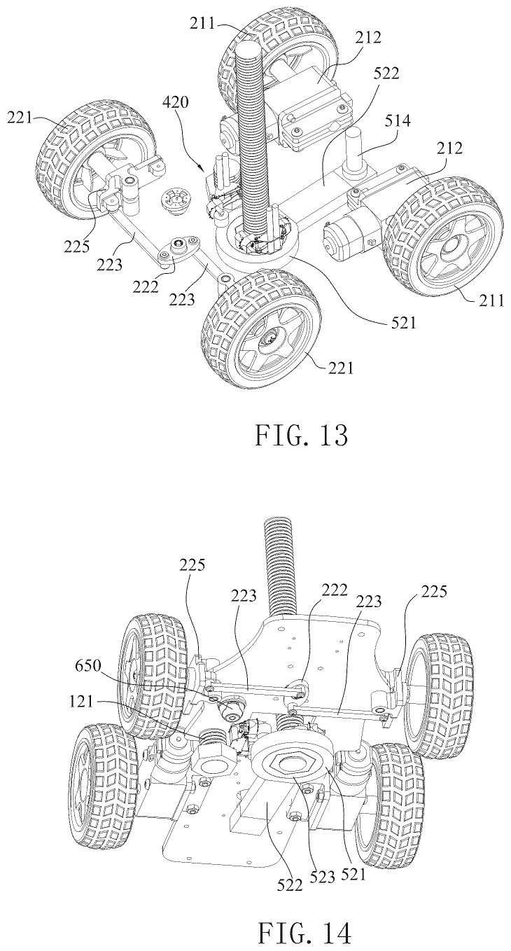

Referring to FIGS. 13 and 14, an end of the rod portion 522 away from the head portion 521 is fixed with a wrench shaft 514, and the wrench shaft 514 passes through the lower plate 120 and is in transmission connection with an output shaft of the wrench motor 510. In this way, the wrench motor 510 can drive the intelligent torque wrench 520 to rotate around the wrench shaft 514.

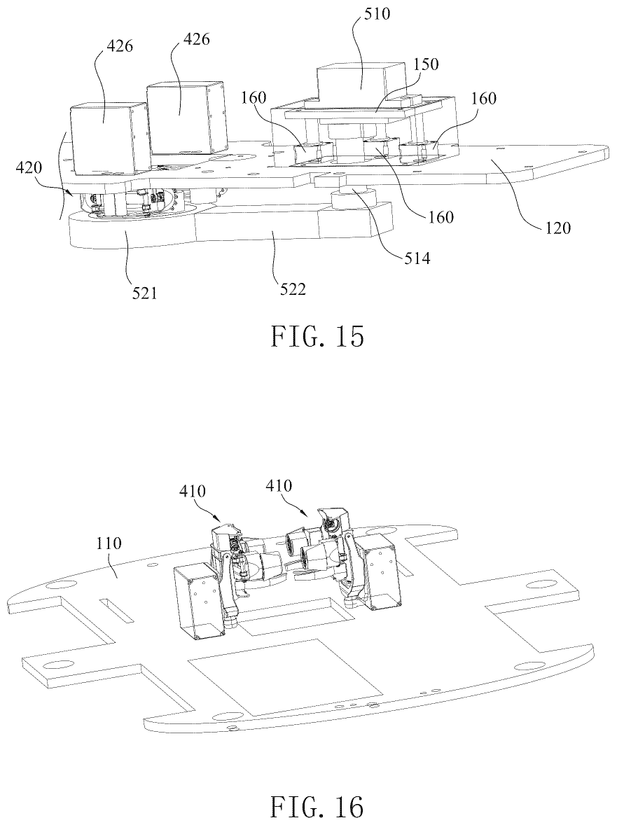

Referring to FIG. 15, in an embodiment, the construction robot further includes a first lifting device mounted on the lower plate 120. In this embodiment, the first lifting device includes a lifting platform 150 and a plurality of lifting motors 160, and the plurality of lifting motors 160 are all mounted on the lower plate 120 for driving the lifting platform 150 to lift. The lifting motor 160 may be a linear servo electric cylinder, certainly, it may alternatively be other devices with lifting function, as long as the device capable of driving the lifting platform 150 to lift, it can be applied in the present invention.

The wrench motor 510 is mounted on the lifting platform 150, and the intelligent torque wrench 520 lifts or lowers along with the lifting platform 150.

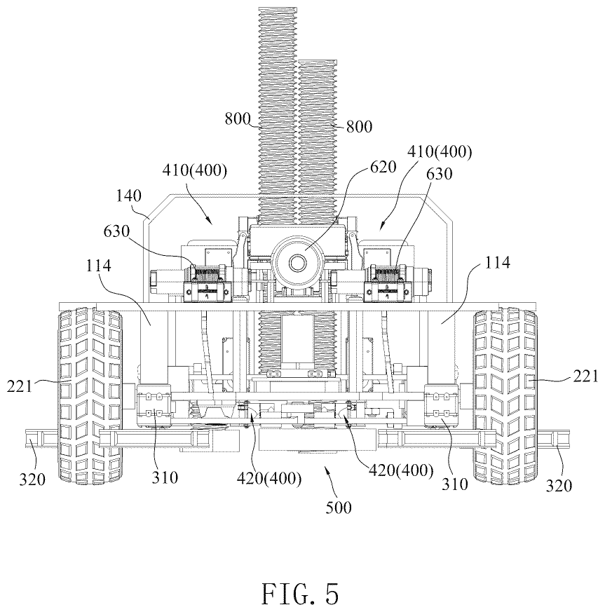

Referring to FIG. 5, the bolt conveying system 400 in this embodiment includes a first bolt conveying device 410 and a second bolt conveying device 420 that is capable of being lifted and lowered, the first bolt conveying device 410 is mounted on the upper plate 110 for driving the bolt to move, and the second bolt conveying device 420 is mounted on the lower plate 120 for driving the bolt to rotate.

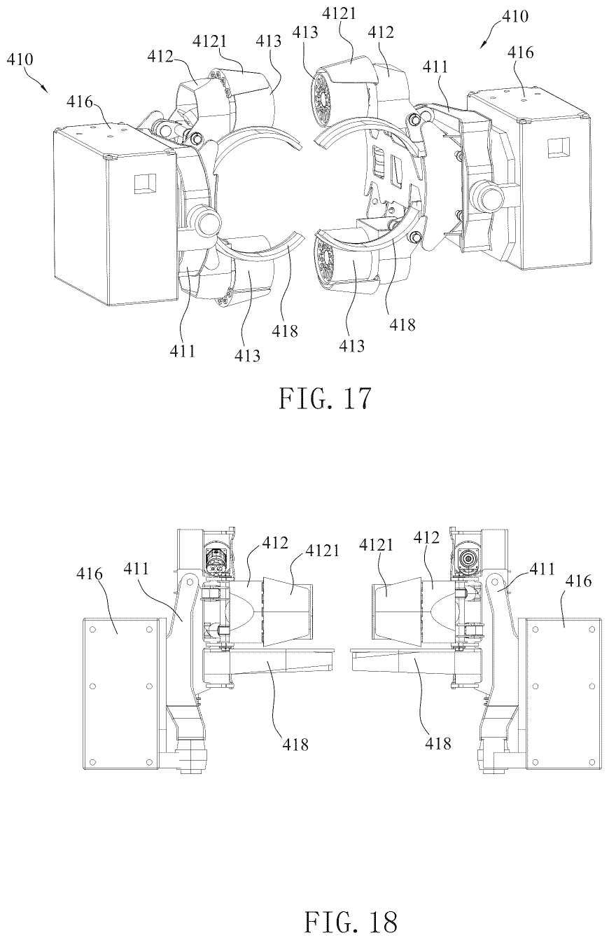

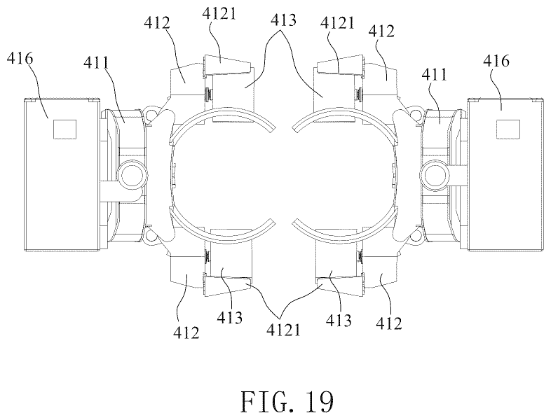

Referring to FIGS. 16 to 19, FIGS. 16 to 19 show the relative positional relationship of the two bolt conveying systems 400. In this embodiment, the two bolt conveying systems 400 are arranged opposite to each other in a left-right direction (see FIG. 5). In other embodiments, the number of the bolt conveying systems 400 may also be one or three, four, eight, etc., and the plurality of bolt conveying systems 400 may be arranged around the through hole of the upper plate 110.

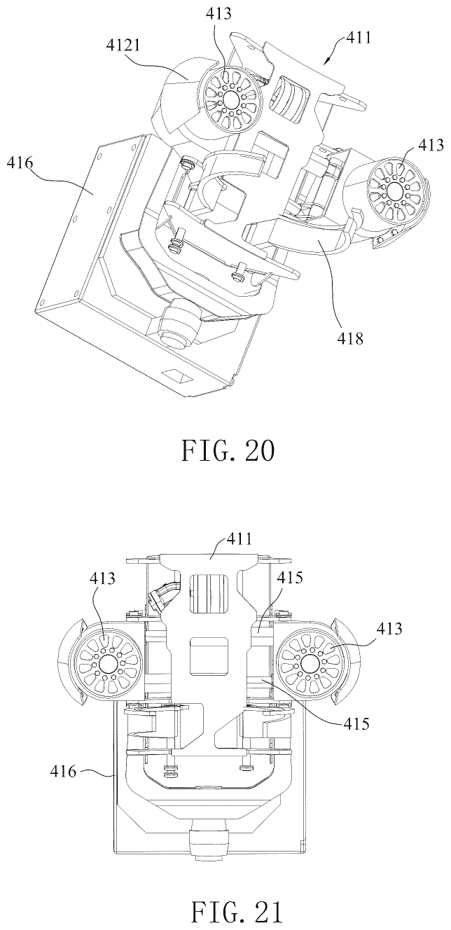

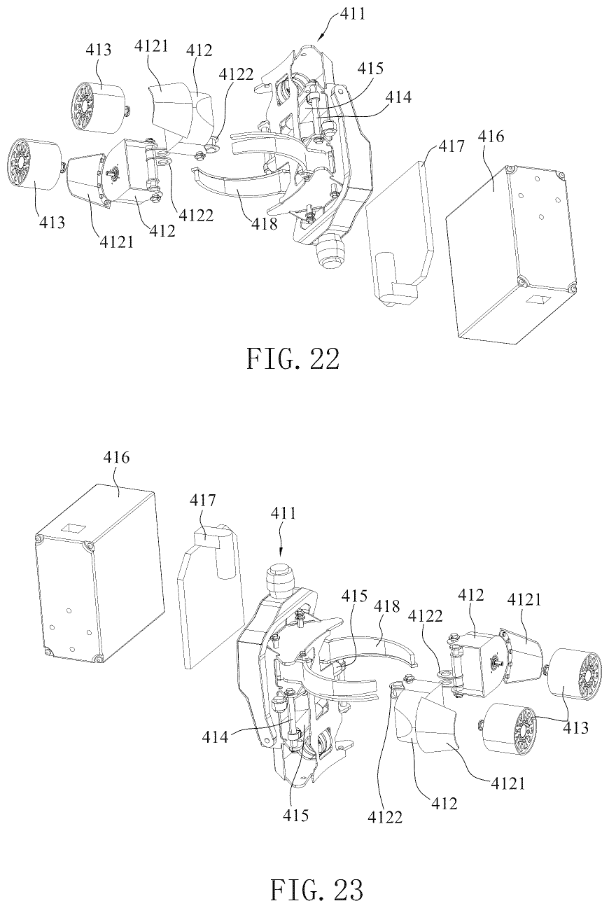

Referring to FIGS. 20 to 23, the first bolt conveying device 410 in this embodiment includes a first bracket 411, two first conveying motors 412 and two first rollers 413. The first bracket 411 is mounted on the upper plate 110, the two first conveying motors 412 are mounted on two sides of the first bracket 411, the two first rollers 413 are respectively mounted on output shafts of the two first conveying motors 412, and the two first rollers 413 are arranged opposite to each other and clamp a bolt on two sides of the bolt. The central axes of the two first rollers 413 are parallel to each other and perpendicular to a central axis of the bolt. The two first conveying motors 412 are further fixed with protective sheets 4121 on their outer sides, respectively, and the two protective sheets 4121 are respectively located on the outer sides of the two first rollers 413 to protect the first rollers 413.

When the two first conveying motors 412 respectively drive the two first rollers 413 to rotate, the bolt 800 to be installed may be moved axially downward.

Referring to FIGS. 20 to 23, the first bolt conveying device 410 further includes two first mounting rods 414 and two first telescopic devices 415. The two first mounting rods 414 are parallel to each other and are respectively fixed on two sides of a front surface of the first bracket 411. The two first conveying motors 412 are respectively rotatably mounted on the two first mounting rods 414. Specifically, the first conveying motor 412 on the right side is rotatably mounted on the first mounting rod 414 on the right side, and the first conveying motor 412 on the left side is rotatably mounted on the first mounting rod 414 on the left side.

Each first conveying motor 412 is provided with a first lug 4122. Positions of the first lugs 4122 disposed on the two first conveying motors 412 are different, for example, the first lug 4122 disposed on the first conveying motor 412 on the right side is located at its lower right corner, and the first lug 4122 disposed on the first conveying motor 412 on the left side is located at its upper left.

The first telescopic devices 415 may be, for example, telescopic cylinders or oil cylinders or other telescopic devices. The two first telescopic devices 415 are parallel to each other and perpendicular to the first mounting rod 414. One end of one first telescopic device of the first telescopic devices 415 is connected to the first mounting rod 414 on the left side, and the other end thereof is connected to the first lug 4122 of the first conveying motor 412 on the right side. When the first telescopic device 415 extends and retracts, it can drive the first conveying motor 412 on the right side to rotate by an angle around the first mounting rod 414 on the right side, thereby driving the first roller 413 on the right side to rotate by an angle.

One end of the other first telescopic device 415 is connected to the first mounting rod 414 on the right side, and the other end thereof is connected to the first lug 4122 of the first conveying motor 412 on the left side. When the first telescopic device 415 extends and retracts, it can drive the first conveying motor 412 on the left side to rotate by an angle around the first mounting rod 414 on the left side, thereby driving the first roller 413 on the left side to rotate by an angle.

The two first telescopic devices 415 drive the two first rollers 413 to rotate by an angle, which can change a distance between the two first rollers 413, thereby adapting to bolts with different diameters.

In an embodiment, referring to FIG. 10, the first bolt conveying device 410 further includes a first counterweight 416, and the first counterweight 416 is arranged on an upper surface of the upper plate 110. The first counterweight blocks 416 are connected to the first brackets 411, and are located on two sides of the first bracket 411 together with the first delivery motors 412. The first counterweight 416 helps enhance the balance and stability of the first bolt conveying device 410.

Further, the first counterweight block 416 may be connected to the first brackets 411 through connecting structures 417, which facilitates the installation of the first counterweight blocks 416 and also facilitates the replacement of the first counterweight blocks 416 with different weights according to actual needs.

In an embodiment, the first bolt conveying device 410 further includes a first limiting structure 418, and the first limiting structure 418 is connected to the first bracket 411 to prevent the bolt from skewing. The first limiting structure 418 may be arc-shaped, disposed on an outer periphery of the bolt, and may form an appropriate gap with the bolt.

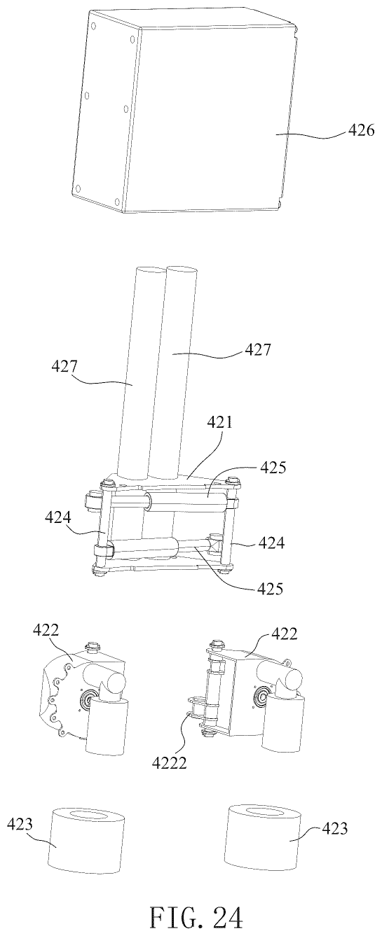

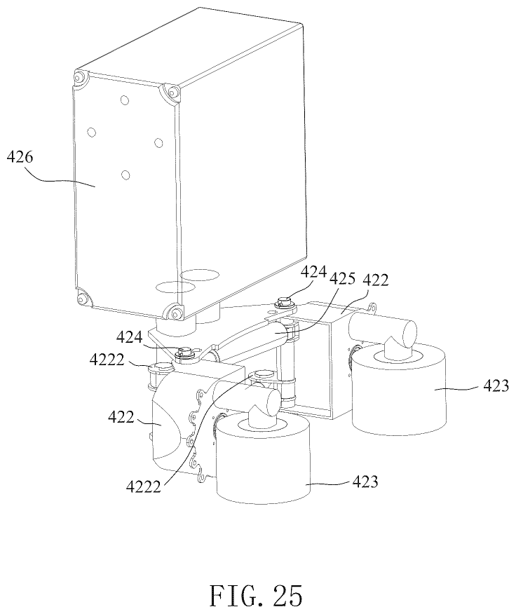

Referring to FIGS. 24 and 25, the second bolt conveying device 420 includes a second lifting device, a second bracket 421, two second conveying motors 422 and two second rollers 423. The second lifting device is mounted on the lower plate 120, the second bracket 421 is mounted on the second lifting device, the two second conveying motors 422 are mounted on two sides of the second bracket 421, the two second rollers 423 are respectively mounted on output shafts of the two second conveying motors 422 through a driven mechanism, and the two second rollers 423 are arranged opposite to each other and clamp a bolt on two sides of the bolt. The central axes of the two second rollers 423 of the second bolt conveying device 420 are parallel to each other and to a central axis of the bolt.

In an embodiment, the second bolt conveying device 420 further includes two second mounting rods 424 parallel to each other and two second telescopic devices 425 parallel to each other. The two second mounting rods 424 are fixed on two sides of the second bracket 421, and the two second conveying motors 422 are respectively rotatably mounted on the two second mounting rods 424.

Each second conveying motor 422 is provided with a second lug 4222. Positions of the second lugs 4222 disposed on the two second conveying motors 422 are different, for example, the second lug 4222 disposed on the second conveying motor 422 on the right side is located at its lower right corner, and the second lug 4222 disposed on the second conveying motor 422 on the left side is located at its upper left corner.

The second telescopic devices 425 may be, for example, telescopic cylinders or oil cylinders or other telescopic devices. The two second telescopic devices 425 are parallel to each other and inclined relative to the second mounting rod 424. One end of one first telescopic device of the second telescopic devices 425 is connected to the second mounting rod 424 on the left side, and the other end thereof is connected to the second lug 4222 of the second conveying motor 422 on the right side.

One end of the other second telescopic device 425 is connected to the second mounting rod 424 on the right side, and the other end thereof is connected to the second lug 4222 of the second conveying motor 422 on the left side.

The two second telescopic devices 425 drive the two second rollers 423 to rotate by an angle, which can change a distance between the two second rollers 423, thereby adapting to bolts with different diameters.

Further, the second bolt conveying device 420 further includes a second counterweight 426, and the second counterweight 426 is fixed on an upper surface of the lower plate 120 and connected to the second bracket 421. The second counterweight 426 helps reduce vibration and shaking during the operation of the second bolt conveying device 420, enhancing the operation stability.

In an embodiment, the second lifting device includes two telescopic rods 427, the telescopic rods 427 pass through the lower plate 120, the telescopic rods 427 are fixed to the lower plate 120, and the second bracket 421 is fixedly connected to ends of the telescopic rod 427, so that the second bolt conveying device 420 is lifted or lowered by the telescopic rods 427. In other embodiments, the telescopic rods 427 may be replaced by rigid rods without telescopic function, and then, the rigid rods may be driven by linear motors mounted in the second counterweight blocks 426 to move upward and downward.

In another implementation, the structure of the second lifting device is similar to that of the first lifting device (e.g., a linear servo electric cylinder) mounted on the upper plate 110, except that the second lifting device is mounted on the lower plate 120, and therefore the lifting function of the second bolt conveying device 420 can also be realized when the second bracket 421 is mounted on the second lifting device.

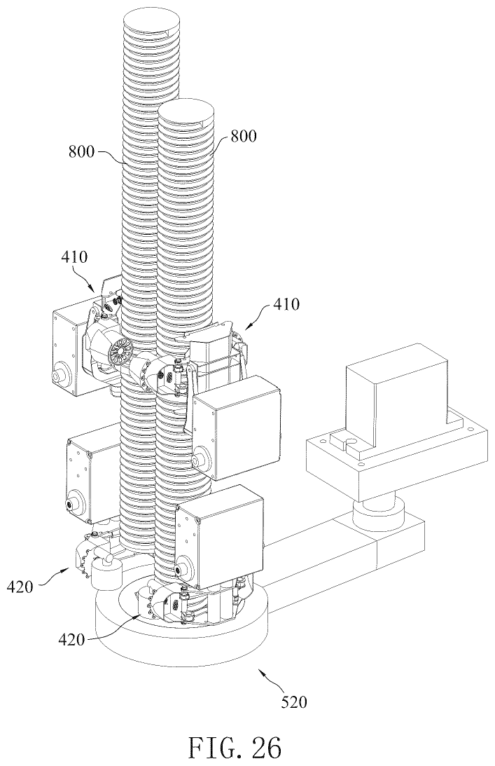

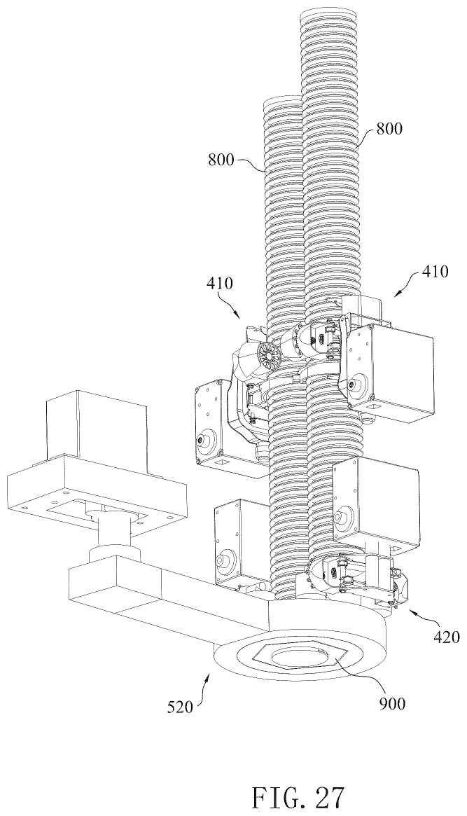

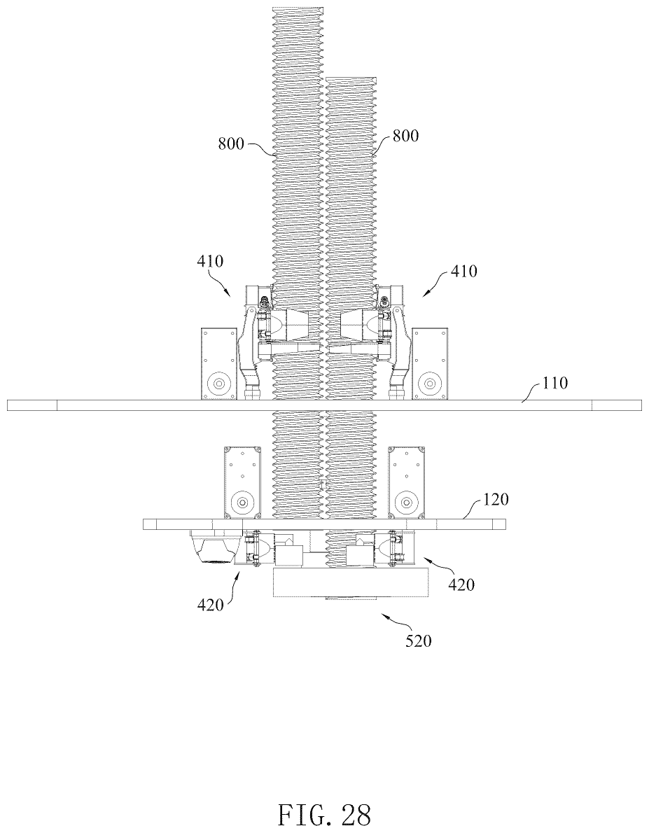

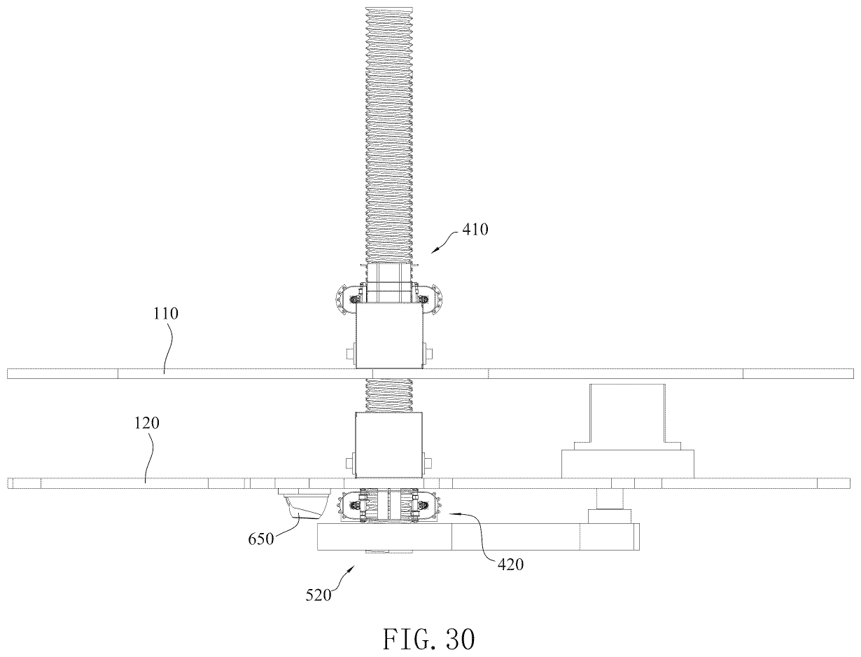

Referring to FIGS. 26 to 30, two bolt conveying systems 400 respectively clamp two bolts 800 to be installed. Each of the bolt delivery systems 400 includes a first bolt delivery device 410 and a second bolt delivery device 420. The first bolt conveying device 410 is mounted on the upper plate 110, the second bolt conveying device 420 is mounted on the lower plate 120, and the positions of the first bolt conveying device 410 and the second bolt conveying device 420 are aligned in up-down direction (vertically).

Central axes of the two first rollers 413 of the two first bolt conveying devices 410 are parallel to each other and clamp a bolt 800 on two sides of the bolt. The central axes of the first rollers 413 are perpendicular to a central axis of the bolt 800. When the two first rollers 413 rotate, the clamped bolt 800 is driven to move downward.

Central axes of the two second rollers 423 of the two second conveying motors 422 are parallel to each other and clamp a bolt 800 on two sides of the bolt. The central axes of the second rollers 423 are parallel to a central axis of the bolt 800, and when the two second rollers 423 rotate, the clamped bolt 800 is driven to rotate.

The nut installation system 500 is located below the lower plate 120 and the fastening nut 900 held by the head portion 521 of the intelligent torque wrench 520 is located directly below one of the bolts 800.

When the bolt 800 moves downward to the intelligent torque wrench 520, an external thread of the bolt 800 starts to engage with an internal thread of the fastening nut 900 in the intelligent torque wrench 520, and at this time, under the coordination of the two first rollers 413 and the fastening nut 900, the bolt 800 moves downward while rotating.

Referring to FIGS. 4 and 14, in the case where a plurality of bolt conveying systems 400 are provided, a spare nut frame 121 is fixed below the lower plate 120, and the spare nut frame 121 may be a screw having an external thread. The number of the spare nut frames 121 may be one or more, and the spare nut frame 121 is arranged on a rotation track of the head portion 521 of the intelligent torque wrench 520. Each spare nut frame 121 may be engaged with one or more spare fastening nuts, which are the same as the fastening nut 900 in the intelligent torque wrench 520 and can be engaged with the bolts 800.

Referring to FIG. 10, the construction robot of the present invention further includes a 360° LiDAR system 610, a primary camera 620, an anti-fall device 630, a battery pack 700, and the like.

The 360° LiDAR system 610 is mounted on the front portion of the upper surface of the upper plate 110, and may be located on the longitudinal centerline X of the construction robot.

The primary camera 620 is mounted on the front end of the upper surface of the upper plate 110, directly in front of the 360° LiDAR system 610.

The 360° LiDAR system 610 is a laser radar system that implements omnidirectional scanning through mechanical rotation, is configured to acquire three-dimensional point cloud data of a surrounding environment in real time. Supplemented with a primary camera 620(a dual-spectrum vision system having a high-definition RGB camera and an infrared camera), it can operate around the clock in low-light conditions.

The two anti-fall devices 630 are mounted on the upper surface of the upper plate 110 and located on two sides of the primary camera 620. The anti-fall device 630 may include a reel fixed to the upper plate 110 and a safety rope capable of being automatically wound onto the reel. When in use, an end of the safety rope may be fixed at a high position of the building, and the anti-fall device 630 can prevent the robot from a potential risk of high-altitude falling in extreme conditions.

The battery pack 700 is mounted at the rear portion of the upper surface of the upper plate 110 to supply electric power to various system. The battery pack 700 may be a modular large-capacity battery system that can be quickly disassembled and replaced, enabling run for 24 hours uninterrupted operation.

Referring to FIG. 4, the lower plate 120 is further mounted with a bottom camera 650, which may adopt a high-definition camera (a dual-spectrum vision system with a high-definition RGB camera and an infrared camera) for collecting information of a through hole for a bolt to pass through on a building, achieving precise screw hole alignment.

The construction robot of the present invention is further provided with two control chips 640, and the two control chips 640 may be disposed on the upper plate 110 and located on two sides of the 360° LiDAR system 610. The control chips 640 integrate an advanced CPU, serving as a hardware brain of the robot, and can combine with an advanced artificial intelligence model to implement autonomous operation.

The construction robot of the present invention can climb the building through manual control or through autonomous or remote control of the control system, carry bolts and fastening nuts for connecting the construction module, and reach a designated position to complete the installation of the bolts and the fastening nuts.

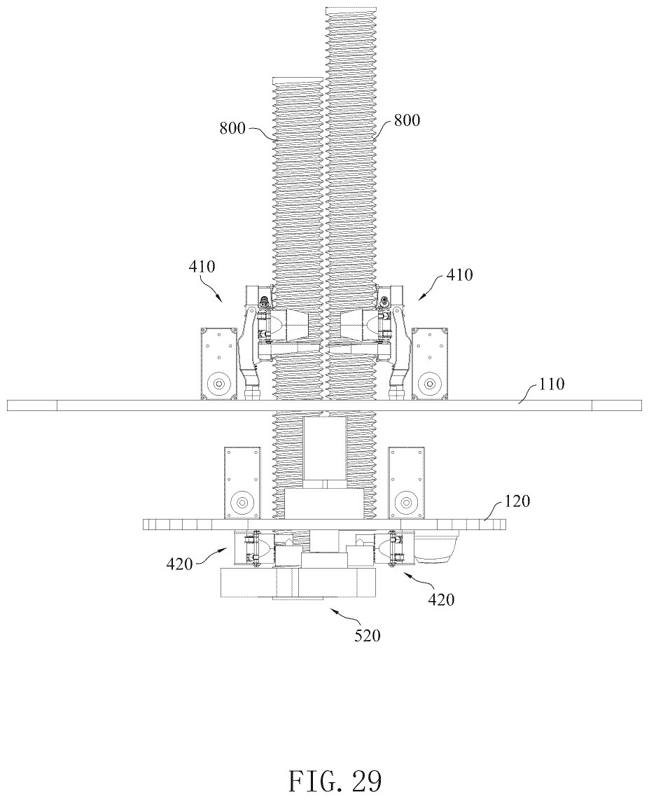

Referring to FIG. 29, preparation steps before the construction robot starts working include: the robot may complete the assembly of at least two sets of bolt-nut assemblies in a single building-climbing task. Before the robot climbs the building, the fastening nuts in a first set of the bolt-nut assembly are engaged at corresponding positions of the intelligent torque wrench, while the fastening nuts in a second set of bolt-nut assembly are engaged on the spare nut frame, and the two bolts of the two bolt-nut assemblies are clamped and carried by two bolt conveying systems, respectively.

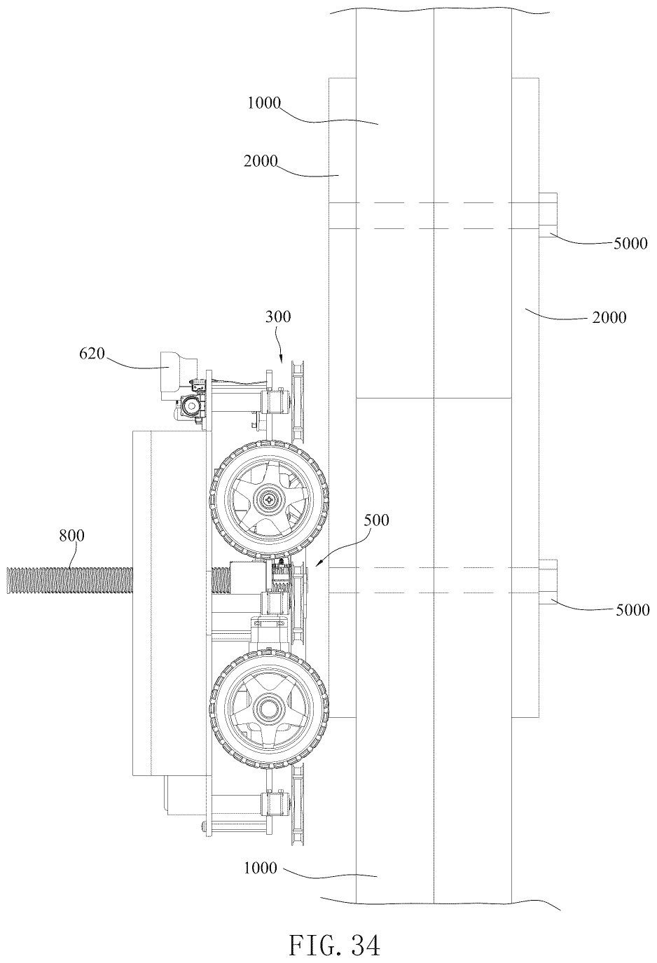

FIGS. 34 to 40 shows schematic diagrams of various steps of installing a bolt by a construction robot under the control of a control system.

Referring to FIG. 34, in step 1: the construction robot climbs upward from a bottom of a lower module 1000 of a building to a connecting plate 2000, and aligns a bolt 800 to be installed with through holes of connecting plates 2000 and a lower module 1000.

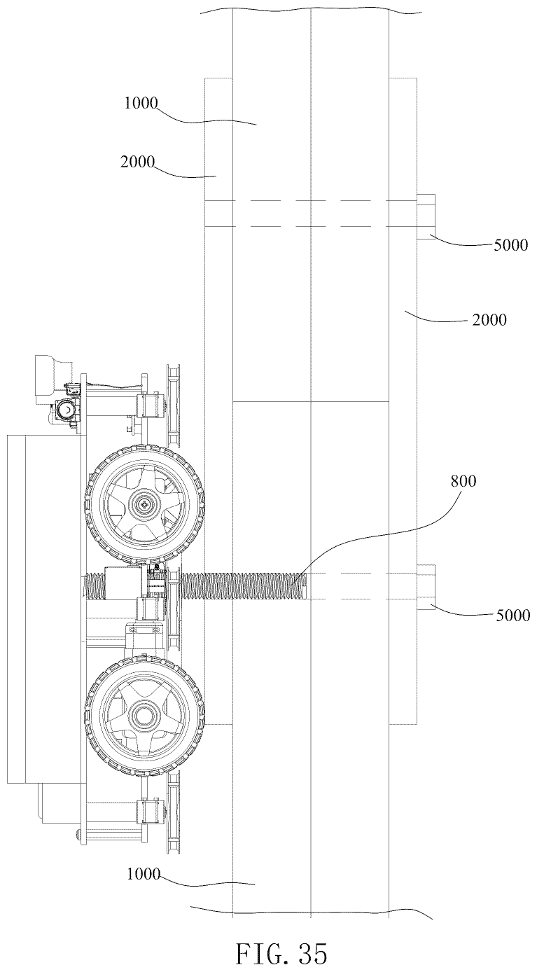

Referring to FIG. 35, in step 2: in the coordination of the first bolt conveying device, the second bolt conveying device and the fastening nut (fixed relative to the intelligent torque wrench), the bolt 800 moves downward while rotating and is inserted into the through hole of the lower module;

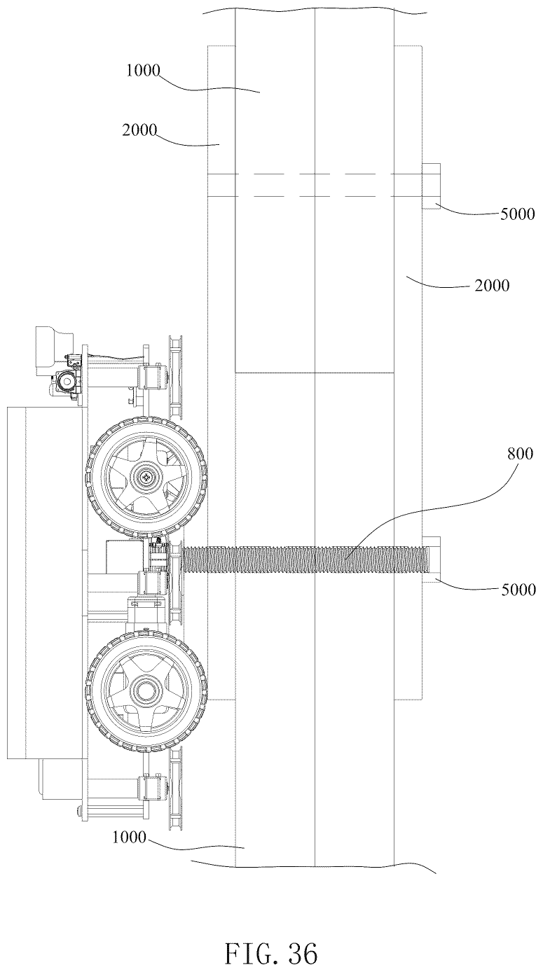

referring to FIG. 36, in step 3: as the bolt 800 to be installed continuously inserted into the through hole, a top end of the bolt 800 is separated from the first bolt conveying device, and under the coordination of the second bolt conveying device and the fastening nut 900, the bolt 800 to be installed continues to move downward while rotating, until it passes through the lower module 1000 to reach a fixing nut 5000 pre-welded on a connecting plate 2000 on the other side of the lower module.

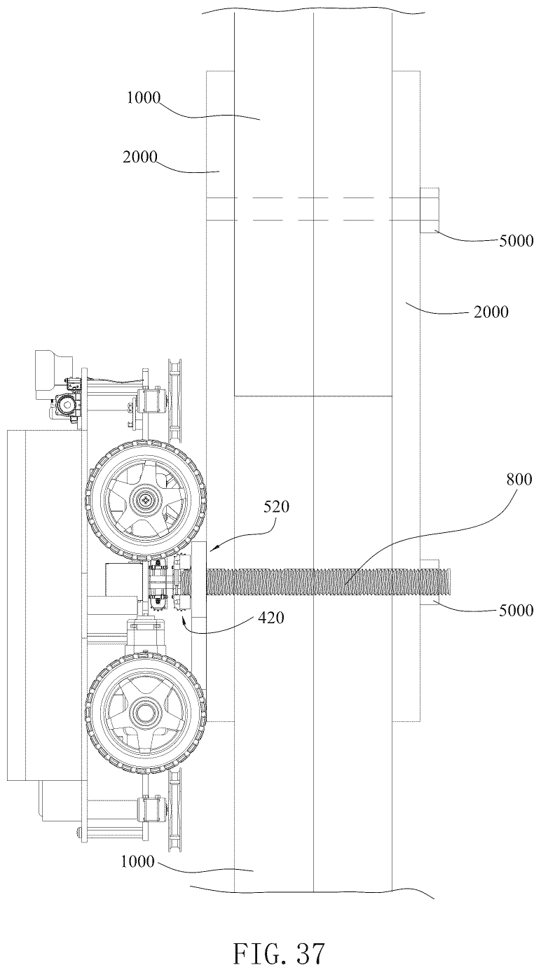

Referring to FIG. 37, in step 4: the second bolt conveying device 420 and the intelligent torque wrench 520 simultaneously descend (that is, approach to the through hole of the module) until the intelligent torque wrench 520 is attached to the lower module 1000, at the same time, after the bolt 800 to be installed keeps moving downward through the fixing nut 5000 for a certain length while rotating, the second bolt conveying device 420 stops working and clamps and fixes the bolt 800 to be installed, the intelligent torque wrench 520 starts rotating, driving the fastening nut 900 to rotate to achieve the effect of tightening the fastening nut 900, and finally reaching the pre-tightening force specified by construction standards;

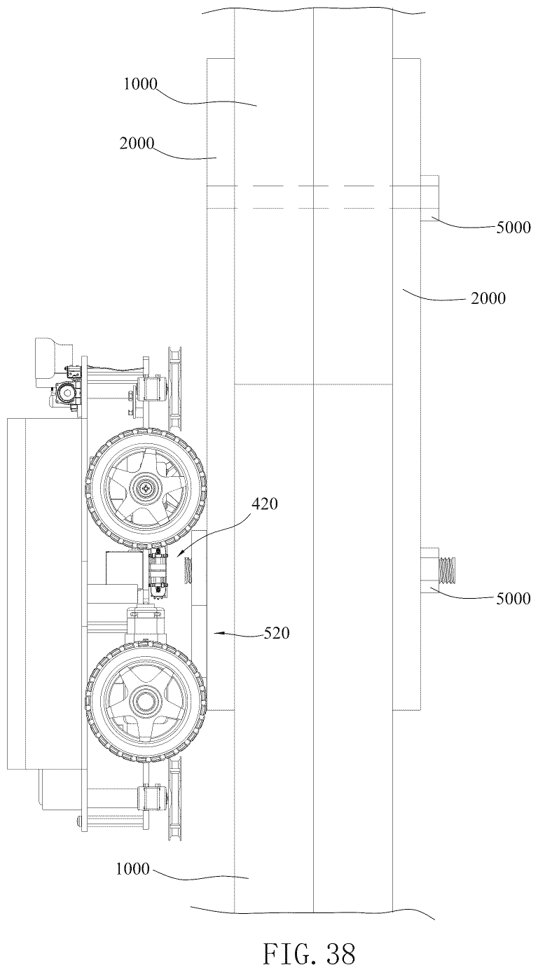

Referring to FIG. 38, in step 5: the second bolt conveying device 420 rises toward the robot, disengaging from the installed bolt 800.

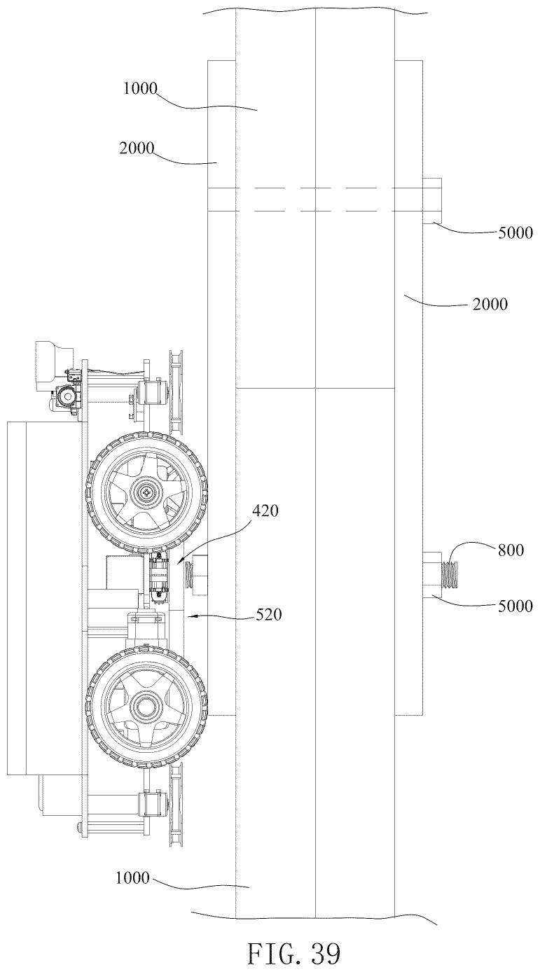

Referring to FIG. 39, in step 6: the intelligent torque wrench 520 rises toward the robot, and disengaging from the tightened fastening nut 900.

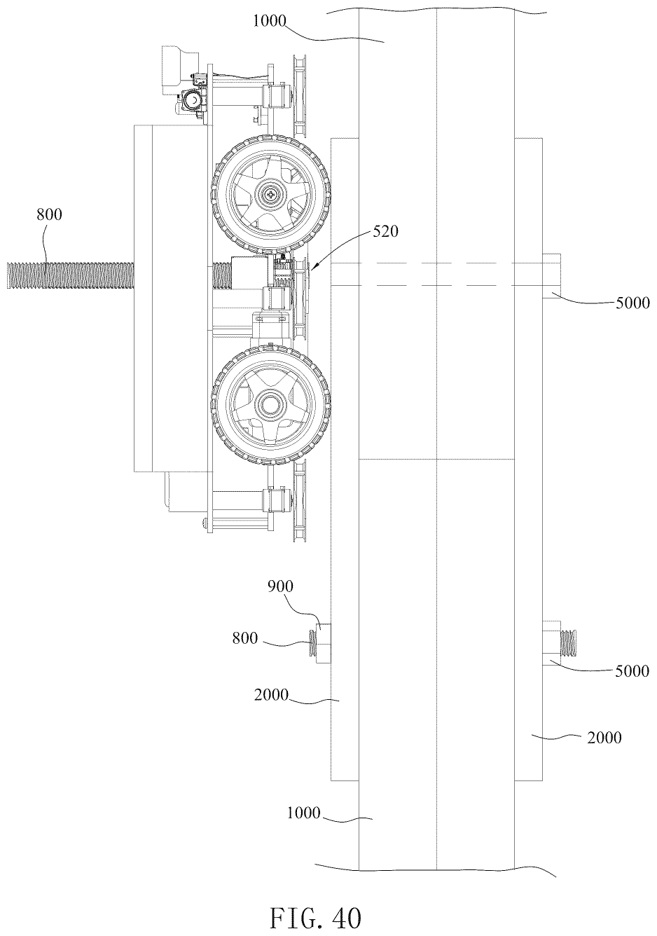

Referring to FIG. 40, in step 7: the robot leaves a current position where the bolt installation has been completed, and moves to another installation position, such as a through hole of the upper module 1000. On the way, the intelligent torque wrench 520 rotates to a spare nut frame, picks-up one spare fastening nut on the spare nut frame, and rotates again to a position directly below another bolt 800 to be installed. After the robot reaches a next designated position, the above steps are repeated again to complete the assembly of another bolt 800 to be installed.

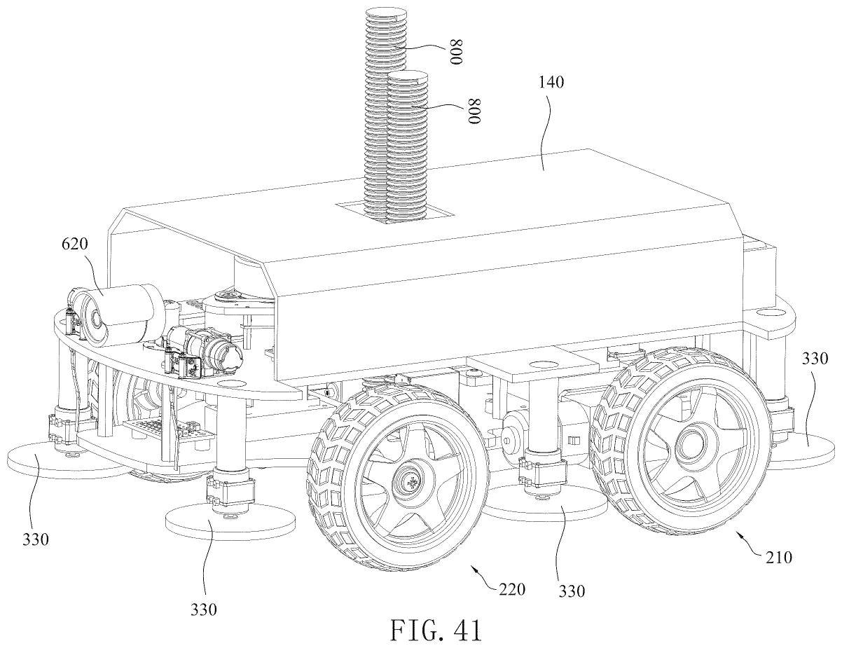

Referring to FIG. 41, in another implementation of the construction robot of the present invention, the adsorption device is configured as magnet discs 330 mounted at ends of the plurality of columns 114. Other structures of this embodiment are basically the same as those of the foregoing embodiment, and will not be repeated herein.

The construction robot of the present invention can be applied not only to modular integrated construction, but also to steel structure buildings, and can also be applied to steel structures such as steel structure bridges, steel structure transmission towers, etc., and in other situations where bolts need to be installed.

Exemplary embodiments of the construction robot proposed by the present invention have been described and/or illustrated in detail above. However, the embodiments of the present invention are not limited to the specific embodiments described herein, but rather, the components and/or steps of each embodiment may be utilized independently and separately from other components and/or steps described herein. Each component and/or step of one embodiment may also be used in combination with other components and/or steps of other embodiments. When introducing elements/components/the like described and/or illustrated herein, the articles “a”, “an”, “the above” and the like are used to indicate the presence of one or more elements/components/etc. The terms “include”, “comprise” and “have” are used to indicate open-ended inclusion and indicate that additional elements/components/etc. may exist in addition to the listed elements/components/etc. Furthermore, the terms “first”, “second” etc., in the claims and the specification are only used as labels, and do not impose numerical limitations on their objects.

Although the construction robot proposed by the present invention has been described according to different specific embodiments, those skilled in the art will recognize that modifications may be made to the implementation of the present invention within the spirit and scope of the claims.

What is claimed is:

1. A construction robot for assembling a modular integrated construction and a steel structure, comprising a frame, and a climbing system, an adsorption system, a nut installation system and a bolt conveying system that are mounted on the frame, and a control system, wherein
the climbing system comprises a driving device and a steering device mounted on the frame;
the adsorption system is configured to keep the construction robot in continuous contact with a vertical or inclined object surface during climbing of the construction robot;
the bolt conveying system is configured to carry and convey a bolt;
the nut installation system is capable of carrying and mounting a fastening nut mating with the bolt; and
the control system is configured to control actions of the climbing system, to control actions of the adsorption system, to control the bolt conveying system to convey the bolt, and to control the nut installation system to install the fastening nut onto the bolt after the bolt is conveyed in place.

2. The construction robot according to claim 1, wherein the frame comprises an upper plate and a lower plate, the upper plate and the lower plate divide the frame into three regions, a region above the upper plate is an upper region, a region below the lower plate is a lower region, and a region between the upper plate and the lower plate is a middle region.

3. The construction robot according to claim 2, wherein a plurality of columns are fixed on a periphery of the upper plate, the plurality of columns extend toward the lower plate and are parallel to each other, the adsorption system comprises fans or magnet discs respectively mounted at ends of the plurality of columns, and the fans or the magnet discs are located below the lower plate.

4. The construction robot according to claim 2, wherein the nut installation system comprises a wrench motor and an intelligent torque wrench, the wrench motor is mounted above the lower plate, the intelligent torque wrench is located below the lower plate and is provided with a wrench shaft, and the wrench shaft is in transmission connection with an output shaft of the wrench motor.

5. The construction robot according to claim 4, further comprising a first lifting device mounted on the upper plate, wherein the wrench motor is mounted on the first lifting device to drive the intelligent torque wrench to lift and lower.

6. The construction robot according to claim 4, wherein the intelligent torque wrench comprises a housing, a driving mechanism and a driven mechanism mounted in the housing, and a sleeve connected to the driving mechanism through the driven mechanism; the sleeve is rotatable relative to the housing; a through hole is provided in the sleeve; and a shape of the through hole is matched with an outer contour shape of the fastening nut.

7. The construction robot according to claim 6, wherein the housing comprises an annular head portion and a rod portion fixed to the head portion, and a longitudinal centerline of the rod portion passes through a center of the annular head portion.

8. The construction robot according to claim 7, wherein the driving mechanism comprises a linear motor mounted in the rod portion; the driven mechanism comprises a ratchet wheel, a pawl engaged with the ratchet wheel, and a rack, a first driven gear, a second driven gear and a ring gear which are engaged in sequence, wherein the rack is connected to an output shaft of the linear motor, the ring gear is mounted in the head portion, the ratchet wheel is rotatably mounted in the ring gear, an end of the pawl is connected to the ring gear, a groove is formed in an inner side of the ring gear, a compression spring is mounted in the groove, and a pre-tightening force of the compression spring acts on the pawl, so that a hook portion of the pawl cooperates with a ratchet of the ratchet wheel.

9. The construction robot according to claim 7, wherein an end of the rod portion away from the head portion fixes the wrench shaft.

10. The construction robot according to claim 2, wherein the bolt conveying system comprises a first bolt conveying device and a second bolt conveying device, the first bolt conveying device is mounted on the upper plate for driving the bolt to move, and the second bolt conveying device is mounted on the lower plate in a liftable manner for driving the bolt to rotate.

11. The construction robot according to claim 10, wherein the first bolt conveying device comprises a first bracket, two first conveying motors and two first rollers, the first bracket is mounted on the upper plate; the two first conveying motors are mounted on two sides of the first bracket; the two first rollers are respectively mounted on output shafts of the two first conveying motors; the two first rollers are arranged opposite to each other, clamp the bolt on two sides of the bolt; and central axes of the two first rollers are parallel to each other and perpendicular to a central axis of the bolt.

12. The construction robot according to claim 11, wherein the first bolt conveying device further comprises two first mounting rods parallel to each other and two first telescopic devices parallel to each other; the two first mounting rods are fixed on two sides of the first bracket; the two first conveying motors are rotatably mounted on the two first mounting rods, respectively; the first conveying motors is provided with a first lug; one end of each of the two first telescopic devices is connected to a corresponding first mounting rod of the two first mounting rods, while the other end thereof is connected to the first lug of a corresponding first conveying motor of the two first conveying motors; and the two first telescopic devices are configured to drive the two first conveying motors to rotate around the two first mounting rods, respectively.

13. The construction robot according to claim 11, wherein the first bolt conveying device further comprises a first counterweight, which is connected to the first bracket and located on a side opposite to the first conveying motor; and
the first bolt conveying device further comprises a first limiting structure, which is disposed on the first bracket to prevent the bolt from skewing.

14. The construction robot according to claim 10, wherein the second bolt conveying device comprises a second lifting device, a second bracket, two second conveying motors and two second rollers, the second lifting device is mounted on the lower plate; the second bracket is mounted on the second lifting device and located below the lower plate; the two second conveying motors are mounted on two sides of the second bracket; the two second rollers are arranged opposite to each other, clamp a bolt on two sides of the bolt, and are respectively driven by the two second conveying motors; and central axes of the two second rollers are parallel to each other and parallel to the central axis of the bolt.

15. The construction robot according to claim 14, wherein the second bolt conveying device further comprises two second mounting rods parallel to each other and two second telescopic devices parallel to each other; the two second mounting rods are fixed on two sides of the second bracket; the two second conveying motors are rotatably mounted on the two second mounting rods, respectively; each of the second conveying motors is provided with a second lug; one end of each of the two second telescopic devices is connected to a corresponding second mounting rod of the two second mounting rods, while the other end is connected to the second lug of a corresponding second conveying motor of the two second conveying motors; and the two second telescopic devices are configured to drive the two second conveying motors to rotate around the two second mounting rods, respectively.

16. The construction robot according to claim 14, wherein the second bolt conveying device further comprises a second counterweight, which is mounted on the lower plate and connected to the second bracket.

17. The construction robot according to claim 2, wherein the driving device comprises two driving motors and two driving wheels mounted on left and right sides of the lower plate, and the two driving wheels are in transmission connection with output shafts of the two driving motors, respectively.

18. The construction robot according to claim 2, wherein the steering device comprises steering wheels rotatably mounted on left and right sides of the lower plate, a turntable rotatably mounted on the lower plate, two first connecting rods respectively movably connected between two sides of the turntable and the two steering wheels, and a steering motor mounted on the lower plate, and the turntable is in transmission connection with an output shaft of the steering motor.

19. The construction robot according to claim 18, wherein pivoting members are disposed on left and right sides of the lower plate, respectively; two steering wheels are respectively fixed on the two pivoting members; and the steering device further comprises a second connecting rod connecting the two pivoting members.

20. The construction robot according to claim 1, wherein a plurality of bolt conveying systems are provided; and the frame is further provided with at least one spare nut frame, each of which has an external thread.

21. The construction robot according to claim 1, further comprising a bolt and a fastening nut mating with the bolt, wherein the bolt is clamped and carried by the bolt conveying system, and the fastening nut is carried by the nut installation system.

22. The construction robot according to claim 1, wherein a primary camera is disposed on a top of the frame, and a bottom camera is disposed on a bottom of the frame.

23. The construction robot according to claim 1, further comprising a 360° LiDAR system, a battery pack and an anti-fall device disposed on the frame.
